(19) United States
(12) Patent Application Publication
(10) Pub. No.: US 2026/0094244 A1
(43) Pub. Date: Apr. 2, 2026

(54) PROCESSING IMAGES USING A MACHINE LEARNING MODEL

(71) Applicant: Lemon Inc., Grand Cayman (KY)

(72) Inventors: Ye Yuan, Los Angeles, CA (US); Fangyi Chen, Los Angeles, CA (US); Lu Xu, Los Angeles, CA (US); Longyin Wen, Los Angeles, CA (US)

(21) Appl. No.: 18/902,825

(22) Filed: Sep. 30, 2024

(51) Int. Cl. G06T 5/60; G06F 40/284; G06T 7/194

(52) U.S. Cl. CPC G06T 5/60; G06F 40/284; G06T 7/194

(57) ABSTRACT

The present disclosure describes techniques for processing an image using a machine learning model. An instruction of decomposing the image into a plurality of layers is received. Visual features of the image are generated. Embeddings indicative of the plurality of layers are generated by a first sub-model of the machine learning model based on the visual features and textual tokens representative of the instruction. Layer images corresponding to the plurality of layers are generated by a second sub-model of the machine learning model based on the embeddings.

### BACKGROUND

Machine learning models are increasingly being used across a variety of industries to perform a variety of different tasks. Such tasks may include image processing. Improved techniques for utilizing machine learning models for image processing are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for processing images using a machine learning model in accordance with the present disclosure.

FIG. 2 shows an example system for processing images using a machine learning model in accordance with the present disclosure.

FIG. 3 shows an example system for processing images using a machine learning model in accordance with the present disclosure.

FIG. 4 shows an example system for processing images using a machine learning model in accordance with the present disclosure.

FIG. 5 shows an example system for processing images using a machine learning model in accordance with the present disclosure.

FIG. 6 shows example instructions for decomposing images in accordance with the present disclosure.

FIG. 7 shows example instructions for decomposing images in accordance with the present disclosure.

FIG. 8 shows an example processed image in accordance with the present disclosure

FIG. 9 shows an example process for processing images using a machine learning model in accordance with the present disclosure.

FIG. 10 shows an example process for processing images using a machine learning model in accordance with the present disclosure.

FIG. 11 shows an example process for processing images using a machine learning model in accordance with the present disclosure.

FIG. 12 shows an example process for processing images using a machine learning model in accordance with the present disclosure.

FIG. 13 shows an example process for processing images using a machine learning model in accordance with the present disclosure.

FIG. 14 shows an example computing device which may be used to perform any of the techniques disclosed herein.

### DETAILED DESCRIPTION OF ILLUSTRATIVE EMBODIMENTS

Decomposing an image into layers can be useful for a variety of different image processing tasks, such as for instance detection, masking, matting, amodal completion, scene graphic generation, depth ordering, and the addition of special effects (e.g., lighting, atmosphere, etc.). Decomposing an image into layers can enable precise editing of individual layers of the image without affecting other layers of the image. However, decomposing an image into multiple semantically meaningful layers can require a variety of complex techniques for scene understanding, such as region-level reasoning, depth-aware localization, open-vocabulary semantics, segmentation, inpainting, etc. As such, improved techniques are needed.

Described herein are improved techniques for image processing using a machine learning model. Described herein is a unified machine learning model that can semantically decompose an image into multiple completed layers following natural-language human instructions. The machine learning model described herein is trained to be generative, promptable, and capable of reasoning, allowing it to conduct instructed layer decomposition on images. Each layer generated by the machine learning model preserves the corresponding visible content in the image and completes the invisible (e.g., occluded) content in the image, with high quality. The natural-language human instructions can specify one or more criteria for the decomposition, such as a granularity for the decomposition (e.g., “Please layer the image with fine granularity” or ““Please layer the image with coarse granularity”), an object-oriented layering (e.g., “Please layer ‘the person in blue shirt’ from the scene”), or a group layering (e.g., “Please layer the group of people from the scene.”). The ability of the machine learning model to decompose an image based on natural-language human instructions facilitates flexible image editing and in-depth scene understandings.

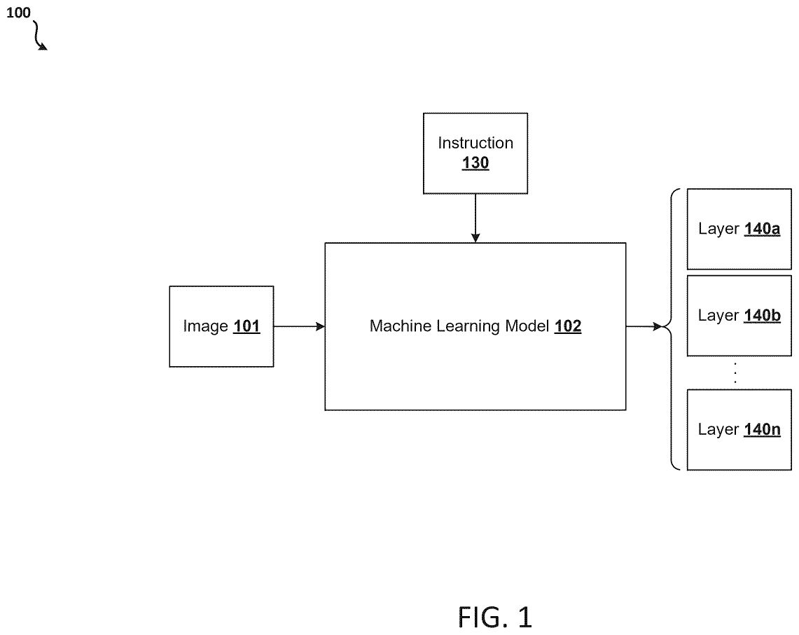

FIG. 1 illustrates an example system 100 in accordance with the present disclosure. The system 100 can include a machine learning model 102. The machine learning model 102 can receive, as input, an image 101 and an instruction 130. The instruction 130 can include an instruction for decomposing the image 101 into a plurality of layers 140a-n. The instruction 130 can include natural-language human instructions that specify one or more criteria for decomposing the image 101 into the plurality of layers 140a-n. For example, the instruction 130 can indicate a granularity level of decomposing the image 101. The instruction 130 can include an instruction to decompose the image 101 based on one or more objects in the image 101. The instruction 130 can include an instruction to decompose the image 101 based on a group of objects in the image 101. The instruction 130 can indicate an order of decomposing the image 101 (e.g., an order in which the plurality of layers 140a-n is to be generated).

The machine learning model 102 can generate embeddings indicative of the plurality of layers 140a-n based on the image 101 and the instruction 130. For example, the machine learning model 102 can generate embeddings indicative of the plurality of layers 140a-n based on visual features (e.g., tokens) representative of the image 101 and textual tokens representative of the instruction 130. The machine learning model 102 can generate an embedding corresponding to each of the plurality of layers 140a-n. For example, the machine learning model 102 can generate a first embedding corresponding to the layer 140a, a second embedding corresponding to the layer 140b, a third embedding corresponding to the layer 140c, and so on.

The machine learning model 102 can generate the plurality of layers 140a-n based on the embeddings. For example, the machine learning model 102 can generate the layer 140a based on the first embedding, can generate the layer 140b based on the second embedding, can generate the layer 140c based on the third embedding, and so on. The machine learning model 102 can generate the plurality of layers 140a-n based on decoding the embeddings. Each of the plurality of layers 140a-n can preserve the corresponding visible content in the image 101 while also completing the invisible (e.g., occluded) content in the image 101, with high quality. The plurality of layers 140a-n can be used to perform an image editing task. For example, a user can combine one or more of the plurality of layers 140a-n to generate an edited version of the image 101. A user can edit one or more of the individual layers among the plurality of layers 140a-n without affecting the other layers among the plurality of layers 140a-n.

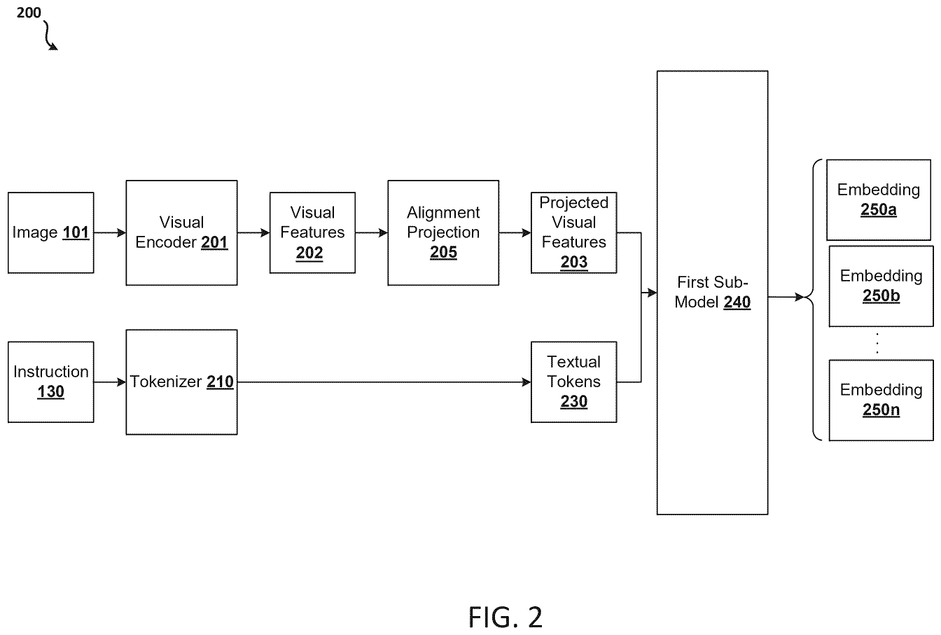

FIG. 2 illustrates an example system 200 in accordance with the present disclosure. As described above, the machine learning model 102 can generate embeddings 250a-n indicative of the plurality of layers 140a-n based on the image 101 and the instruction 130. To generate the embeddings 250a-n, the machine learning model 102 can generate visual features 202 representative of the image 101 and textual tokens 230 representative of the instruction 130. The machine learning model 102 can include a visual encoder 201. The visual encoder 201 can include, for example, a Contrastive Language-Image Pre-Training (CLIP) encoder. The visual encoder 201 can receive, as input, the image 101. The visual encoder 201 can generate the visual features 202 based on the image 101. The machine learning model 102 can include a tokenizer 210. The tokenizer 210 can receive, as input, the instruction 130. The tokenizer 210 can generate the textual tokens 230 based on the instruction 130.

The machine learning model 102 can include an alignment projection component 205. The alignment projection component 205 can include, for example, a multilayer perceptron (MLP). The alignment projection component 205 can project the visual features 202 to align with the textual tokens 230. For example, the alignment projection component 205 can project the visual features 202 into an input space of a first sub-model 240 of the machine learning model 102. The projected visual features 203 and the textual tokens 230 can be input into the first sub-model 240 of the machine learning model 102. The first sub-model 240 can include, for example, a multimodal large language model.

The first sub-model 240 of the machine learning model 102 can receive, as input, the projected visual features 202a-n and the textual tokens 230. The first sub-model 240 can generate the embeddings 250a-n indicative of the plurality of layers 140a-n based on the projected visual features 202 and the textual tokens 230. For example, the first sub-model 240 can generate the embedding 250a indicative of the layer 140a, the embedding 250b indicative of the layer 140b, the embedding 250c indicative of the layer 140c, and so on. Each of the embeddings 250a-n can be used to reconstruct the corresponding layer among the plurality of layers 140a-n.

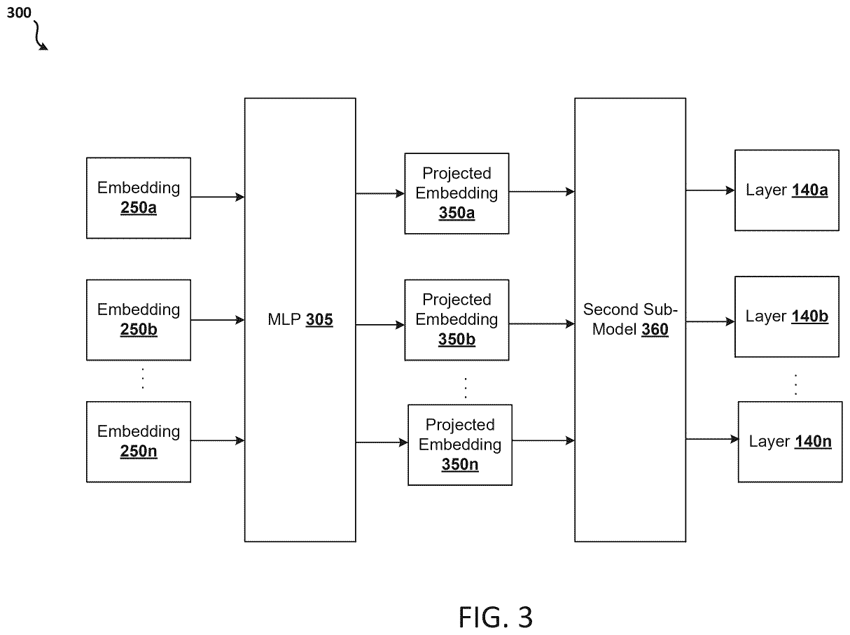

As shown in the example system 300 of FIG. 3, the embeddings 250a-n can be input into an MLP 305. The MLP 305 can project the embeddings 250a-n into an input space of a second sub-model 360 of the machine learning model 102. In embodiments, the image 101 can be input into the second sub-model 360. The MLP 305 can project the embeddings 250a-n to align with noised latent representations of the image 101 generated by the second sub-model 360 of the machine learning model 102. The second sub-model 360 of the machine learning model 102 can include, for example, a stable diffusion model.

The second sub-model 360 of the machine learning model 102 can receive, as input, the projected embeddings 350a-n. The second sub-model 360 can generate the plurality of layers 140a-n based on the projected embeddings 350a-n. For example, the second sub-model 360 can generate the layer 140a based on the projected embedding 350a, the layer 140b based on the projected embedding 350b, the layer 140c based on the projected embedding 350c, and so on. The second sub-model 360 can generate the plurality of layers 140a-n by iteratively denoising the noised latent representations of the image 101 based on the projected embeddings 350a-n. Each of the plurality of layers 140a-n can include an image, such as a red green blue (RGB) image or a red green blue alpha (RGBA) image.

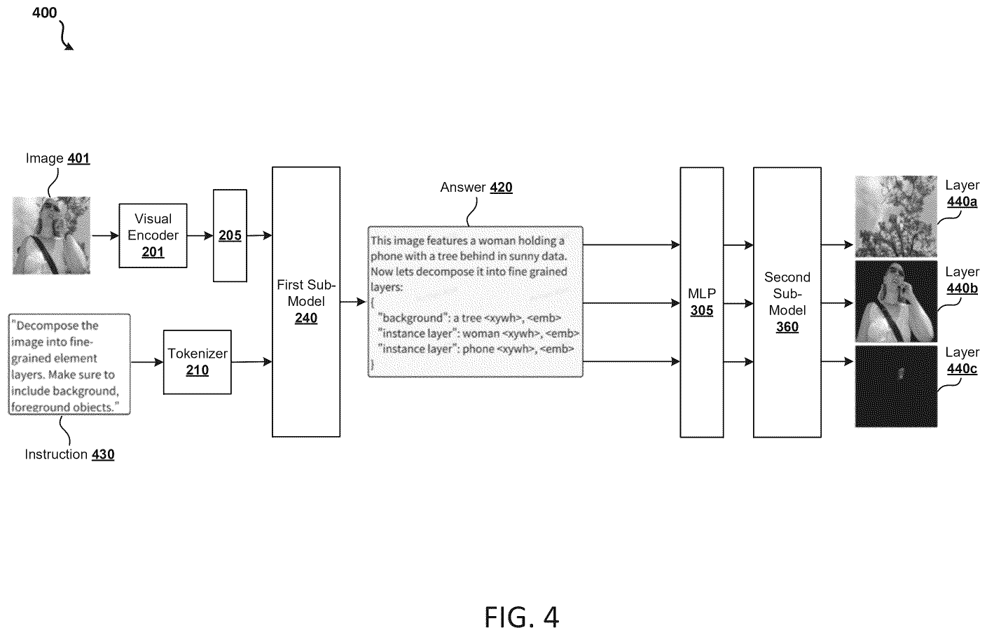

FIG. 4 illustrates an example system 400 in accordance with the present disclosure. The system 400 can include the machine learning model 102. For example, the system 400 can include the visual encoder 201, the tokenizer 210, the alignment projection component 205, the first sub-model 240, the MLP 305, and the second sub-model 360. An image 401 can depict a women holding a phone with a tree in the background. A user may want to decompose the image 401 into fine-grained layers including the background and foreground objects.

The image 401 can be input into the visual encoder 201. The visual encoder 201 can receive, as input, the image 401. The visual encoder 201 can generate the visual features based on the image 401. An instruction 430 including natural language decomposition instructions can be input into the tokenizer 210. The tokenizer 210 can receive, as input, the instruction 430. The tokenizer 210 can generate textual tokens based on the instruction 430. The alignment projection component 205 can project the visual features to align with the textual tokens. For example, the alignment projection component can project the visual features into the input space of the first sub-model 240. The projected visual features and the textual tokens can be input into the first sub-model 240.

The first sub-model 240 of the machine learning model 102 can receive, as input, the projected visual features and the textual tokens. The first sub-model 240 can generate and output a response 420 based on the projected visual features and the textual tokens. The response 420 can include a textual answer to the instruction 430. For example, the response 420 can include a textual description of the image 401. The response 420 can include a list of textual descriptions of each of a plurality of layers 440a-c of the image 401. The response 420 can include embeddings indicative of the plurality of layers 440a-c. The response 420 can be output in the form of a JSON file, for example. The embeddings indicative of the plurality of layers 440a-c can be input into the MLP 305.

The MLP 305 can project the embeddings indicative of the plurality of layers 440a-c into an input space of the second sub-model 360 of the machine learning model 102. In embodiments, the image 401 can also be input into the second sub-model 360. The MLP 305 can project the embeddings indicative of the plurality of layers 440a-c to align with noised latent representations of the image 401 generated by the second sub-model 360 of the machine learning model 102.

The second sub-model 360 of the machine learning model 102 can receive, as input, the projected embeddings indicative of the plurality of layers 440a-c. The second sub-model 360 can generate the plurality of layers 440a-c based on the projected embeddings indicative of the plurality of layers 440a-c. For example, the second sub-model 360 can generate the layer 440a depicting the background of the image 401 (e.g., the tree) based on the projected embedding indicative of layer 440a, the layer 140b depicting the woman in the image 401 based on the projected embedding indicative of layer 440b, and the layer 140c depicting the phone based on the projected embedding indicative of layer 440c. The second sub-model 360 can generate the plurality of layers 440a-c by iteratively denoising the noised latent representations of the image 401 based on the projected embeddings indicative of the plurality of layers 440a-c. Each of the plurality of layers 440a-c can include an image, such as a RGB image or a RGBA image.

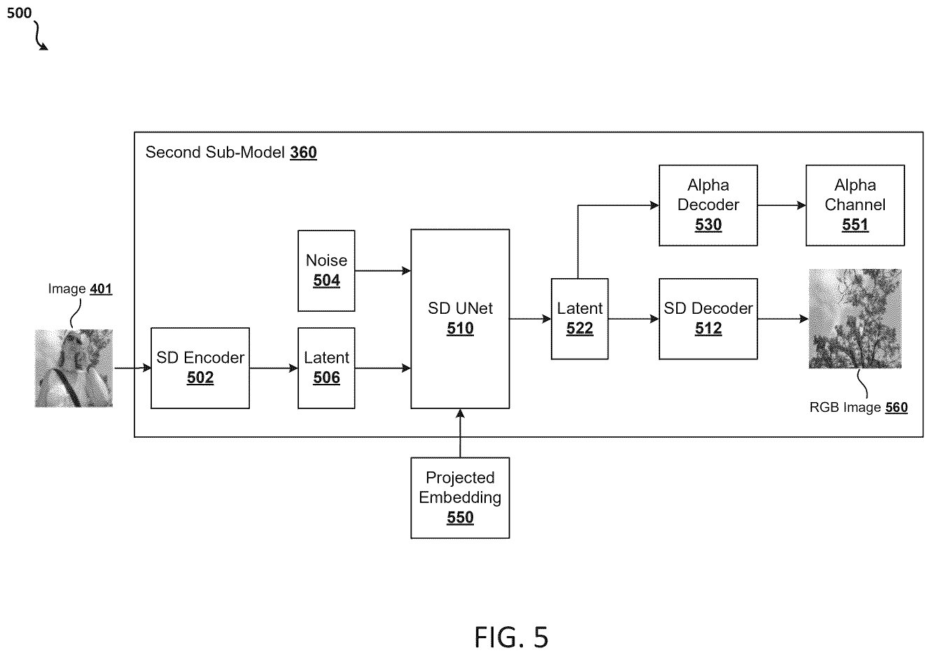

FIG. 5 illustrates an example system 500 in accordance with the present disclosure. As described above, in embodiments, the image 401 and the projected embeddings indicative of the plurality of layers 440a-n can be input into the second sub-model 360. The second sub-model 360 can include a stable diffusion encoder 502, a stable diffusion u-net 510, a stable diffusion decoder 512, and an alpha decoder 530. The image 401 can be input into the stable diffusion encoder 502. The stable diffusion encoder 502 can generate latent representations 506 of the image 401. Noise 504 can be added to the latent representations 506 of the image 401 to generate noised latent representations of the image 401. The noised latent representations of the image 401 can be input into the stable diffusion u-net 510. The MLP 305 (not pictured in FIG. 5) can project the embeddings indicative of the plurality of layers 440a-n to align with the noised latent representations of the image 401. The stable diffusion u-net 510 can receive, as input, the projected embeddings indicative of the plurality of layers 440a-c. For example, the stable diffusion u-net 510 can receive, as input, the projected embedding 550 indicative of the layer 440a.

The stable diffusion u-net 510 can generate a latent representation for each of the plurality of layers 440a-c based on the noised latent representations of the image 401 and a corresponding embedding among embeddings indicative of the plurality of layers 440a-c. For example, the stable diffusion u-net 510 can generate a latent representation 522 for the layer 440a based on the noised latent representations of the image 401 and the projected embedding 550 indicative of the layer 440a. The latent representation 522 can be input into the stable diffusion decoder 512 and the alpha decoder 530. The stable diffusion decoder 512 can generate a RGB image 560 corresponding to the layer 440a based on the latent representation 522. The alpha decoder 530 can generate an alpha channel 551 corresponding to the layer 440a based on the latent representation 522. The layer 440a can be generate by concatenating the alpha channel 551 and the RGB image 560. This process can be repeated for the layer 440b and the layer 440c.

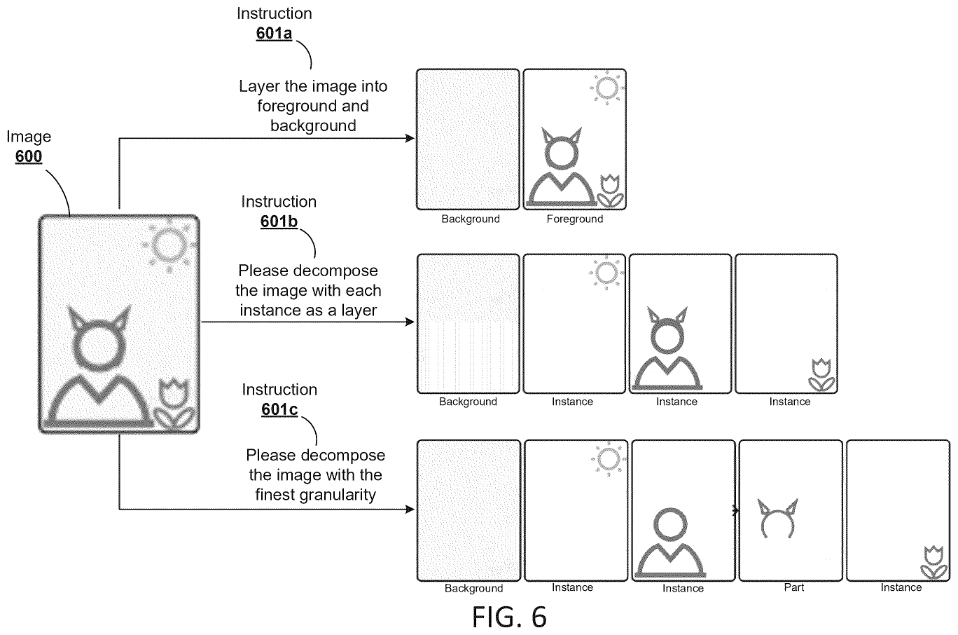

FIG. 6 shows an example instructions that a user can provide to the machine learning model 102 for decomposing an image 600. If the user wants to decompose the image 600 into two layers, one layer depicting the foreground of the image 600 and another layer depicting the background of the image 600, the user can input an instruction 601a into the machine learning model 102. The machine learning model 102 can receive the instruction 601a. In response to receiving the instruction 601a, the machine learning model 102 can generate a layer image (e.g., a RGBA image) depicting the foreground of the image 600 and another layer image depicting the background of the image 600.

If the user wants to decompose the image 600 based on instances in the image 600, the user can input an instruction 601b into the machine learning model 102. The machine learning model 102 can receive the instruction 601b. In response to receiving the instruction 601b, the machine learning model 102 can generate a plurality of layer images (e.g., a plurality of RGBA images), with each of the plurality of layers images depicting a particular instance in the image 600. Similarly, if the user wants to decompose the image 600 with the finest granularity, the user can input an instruction 601c into the machine learning model 102. The machine learning model 102 can receive the instruction 601c. In response to receiving the instruction 601c, the machine learning model 102 can generate a plurality of layer images (e.g., a plurality of RGBA images), with each of the plurality of layers images depicting a particular instance or part in the image 600

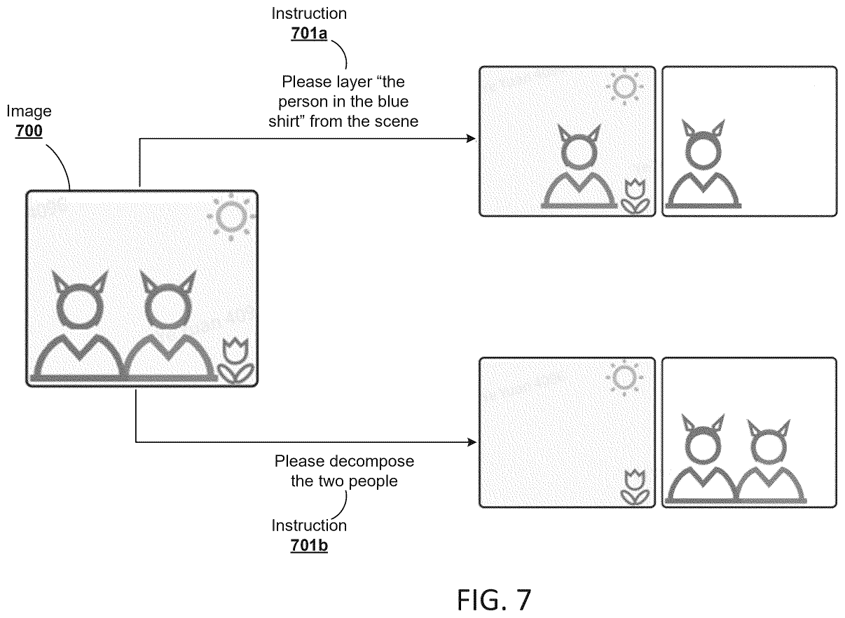

FIG. 7 shows an example instructions that a user can provide to the machine learning model 102 for decomposing an image 700. If the user wants to layer a particular object (e.g., the person in the blue shirt) from the image 700, the user can input an instruction 701a into the machine learning model 102. The machine learning model 102 can receive the instruction 701a. In response to receiving the instruction 701a, the machine learning model 102 can generate a layer image (e.g., a RGBA image) depicting the object (e.g., the person in the blue shirt) and another layer image depicting the remainder of the image 700. If the user wants to layer a group of objects (e.g., the two people) from the image 700, the user can input an instruction 701b into the machine learning model 102. The machine learning model 102 can receive the instruction 701b. In response to receiving the instruction 701b, the machine learning model 102 can generate a layer image (e.g., a RGBA image) depicting the group of objects (e.g., the two people) and another layer image depicting the remainder of the image 700.

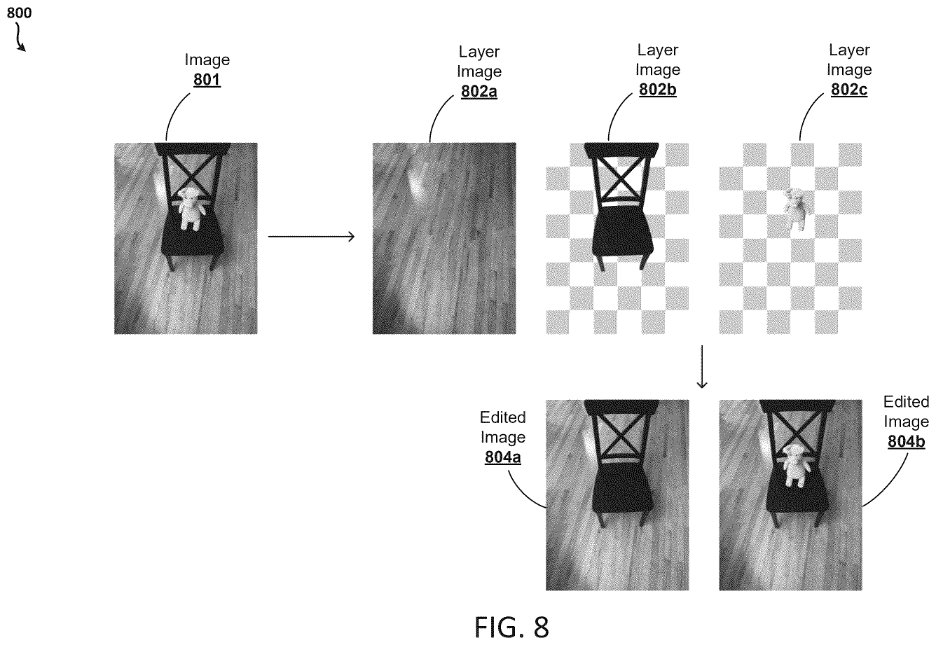

FIG. 8 shows an example system 800 for editing an image 801. The image 801 can depict a stuffed animal sitting in a chair that is placed on a floor. The machine learning model 102 can decompose the image 801 into a plurality of layers. For example, the machine learning model 102 can generate a plurality of layer images 802a-c. The first layer image 802a can depict the background of the image 801 (e.g., the floor). The second layer image 802b can depict a first object in the image 801 (e.g., the chair). The third layer image 802c can depict a second object in the image 801 (e.g., the stuffed animal). In embodiments, the user can edit one or more of the plurality of layer images 802a-c without affecting the other layer images among the plurality of layer images 802a-c.

The image 801 can be edited based on the layer images 802a-c. A user can combine one or more of the layer images 802a-c to generate an edited version of the image 801. For example, the first layer image 802a and the second layer image 802b can be combined to generate an edited image 804a. The edited image 804a can depict the chair on the floor but does not depict the stuffed animal. Similarly, the first layer image 802a, the second layer image 802b, and the third layer image 802c can be combined to generate an edited image 804b. The edited image 804a can depict the stuffed animal sitting in the chair that is placed on the floor. The edited image 804b can be a reconstruction of the image 801.

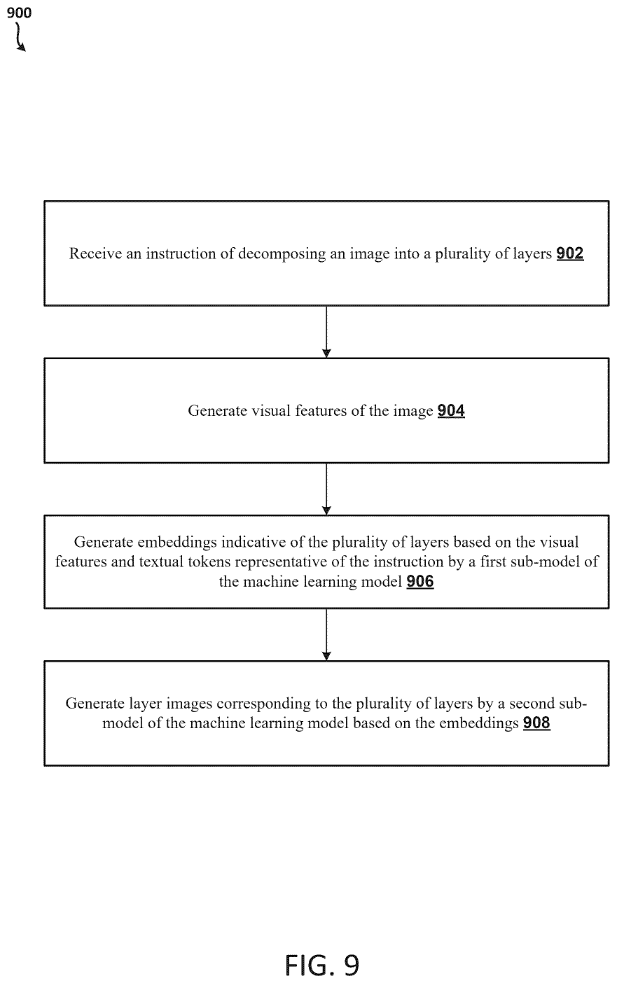

FIG. 9 shows an example process 900 for processing images using a machine learning model. Although depicted as a sequence of operations in FIG. 9, those of ordinary skill in the art will appreciate that various embodiments may add, remove, reorder, or modify the depicted operations.

At 902, an instruction (e.g., instruction 130) of decomposing an image (e.g., image 101) into a plurality of layers can be received. The instruction can include natural-language human instructions that specify one or more criteria for decomposing the image into the plurality of layers. For example, the instruction can indicate a granularity level of decomposing the image. The instruction can include an instruction to decompose the image based on one or more objects in the image 101. The instruction can include an instruction to decompose the image based on a group of objects in the image. The instruction can indicate an order of decomposing the image (e.g., an order in which the plurality of layers is to be generated). At 904, visual features (e.g., visual features 202) can be generated. The visual features can be representative of the image.

At 906, embeddings (e.g., embeddings 250a-n) indicative of the plurality of layers can be generated. The embeddings can be generated based on the visual features and textual tokens (e.g., textual tokens 230) representative of the instruction. The embeddings can be generated by a first sub-model (e.g., first sub-model 240) of a machine learning model (e.g., machine learning model 102). The first sub-model can generate an embedding corresponding to each of the plurality of layers. For example, the first sub-model can generate a first embedding corresponding to the first layer among the plurality of layers, a second embedding corresponding to the second layer among the plurality of layers, a third embedding corresponding to the third layer among the plurality of layers, and so on.

At 908, layer images (e.g., plurality of layers 140a-n) corresponding to the plurality of layers can be generated. The layer images can be generated by a second sub-model (e.g., second sub-model 360) of the machine learning model. The layer images can be generated based on the embeddings. For example, the second sub-model can generate a first layer image based on the embedding corresponding to the first layer, a second layer image based on the embedding corresponding to the second layer, a third layer image based on the embedding corresponding to the third layer, and so on.

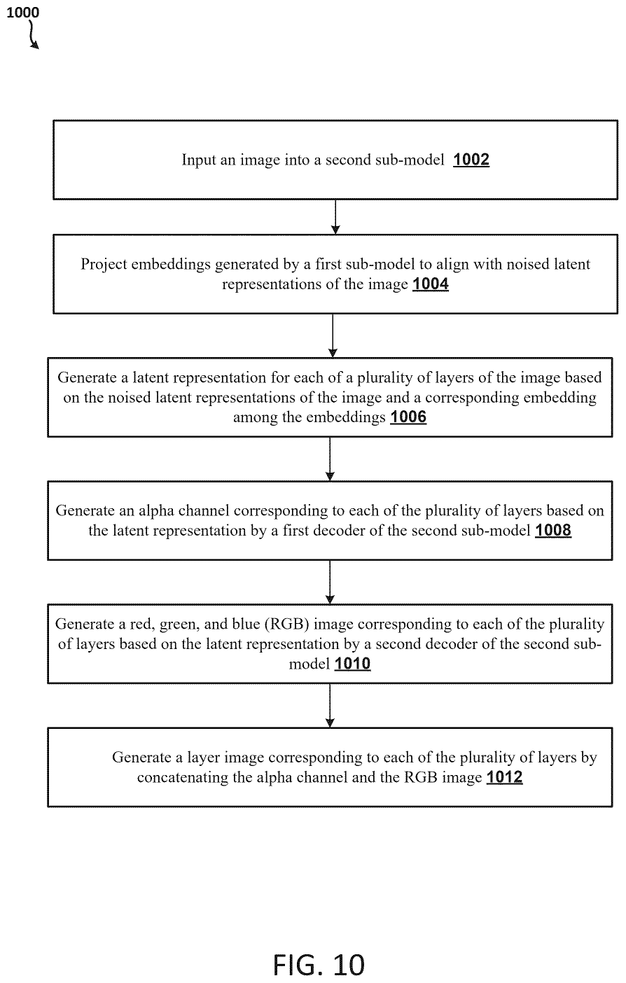

FIG. 10 shows an example process 1000 for processing images using a machine learning model. Although depicted as a sequence of operations in FIG. 10, those of ordinary skill in the art will appreciate that various embodiments may add, remove, reorder, or modify the depicted operations.

A first sub-model (e.g., first sub-model 240) of a machine learning model (e.g., machine learning model 102) can generate embeddings indicative of a plurality of layers (e.g., plurality of layers 440a-c). The embeddings indicative of the plurality of layers can be projected into an input space of a second sub-model (e.g., second sub-model 360) of the machine learning model. At 1002, an image (e.g., image 401) can be input into the second sub-model of the machine learning model. The second sub-model can generate noised latent representations of the image based on the image. At 1004, embeddings generated by the first sub-model can be projected to align with the noised latent representations of the image.

At 1006, a latent representation (e.g., latent representations 522) for each of the plurality of layers of the image can be generated. The latent representation for each of the plurality of layers of the image can be generated based on the noised latent representations of the image and the corresponding embedding among the embeddings indicative of the plurality of layers. The latent representation for each of the plurality of layers of the image can be input into a first decoder (e.g., alpha decoder 530) and a second decoder (e.g., stable diffusion decoder 512) of the second sub-model. At 1008, an alpha channel (e.g., alpha channel 551) corresponding to each of the plurality of layers can be generated. The alpha channel corresponding to each of the plurality of layers can be generated based on the latent representation by the first decoder of the second sub-model. At 1010, a RGB image (e.g., RGB image 560) corresponding to each of the plurality of layers can be generated. The RGB image corresponding to each of the plurality of layers can be generated based on the latent representation by the second decoder of the second sub-model. At 1012, a layer image corresponding to each of the plurality of layers can be generated. The layer image corresponding to each of the plurality of layers can be generated by concatenating the corresponding alpha channel and the corresponding RGB image.

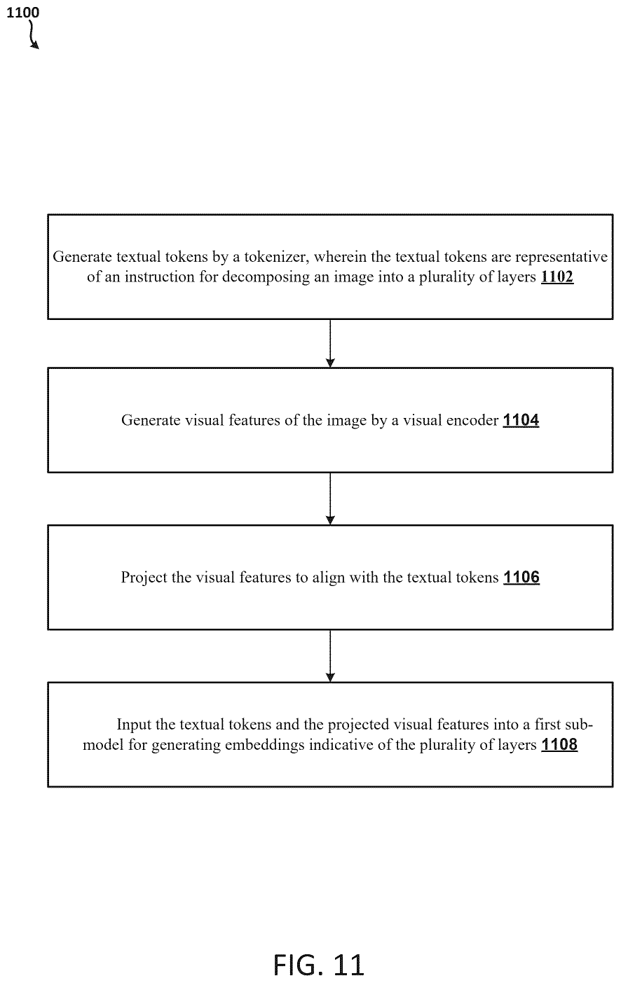

FIG. 11 shows an example process 1100 for processing images using a machine learning model. Although depicted as a sequence of operations in FIG. 11, those of ordinary skill in the art will appreciate that various embodiments may add, remove, reorder, or modify the depicted operations.

At 1102, textual tokens (e.g., textual tokens 230) can be generated. The textual tokens can be generated by a tokenizer (e.g., tokenizer 210). The textual tokens can be representative of an instruction (e.g., instruction 130) for decomposing an image (e.g., image 101) into a plurality of layers (e.g., plurality of layers 140a-n). The tokenizer can receive, as input, the instruction. The tokenizer can generate the textual tokens based on the instruction. At 1104, visual features (e.g., visual features 202) of the image can be generated. The visual features can be generated by a visual encoder (e.g., the visual encoder 201). The visual encoder can receive, as input, the image. The visual encoder can generate the visual features based on the image. At 1106, the visual features can be projected to align with the textual tokens. The visual features can be projected to align with the textual tokens by an alignment projection component (e.g., alignment projection component 205). At 1108, the textual tokens and the projected visual features can be input into a first sub-model (e.g., first sub-model 240) for generating embeddings indicative of the plurality of layers.

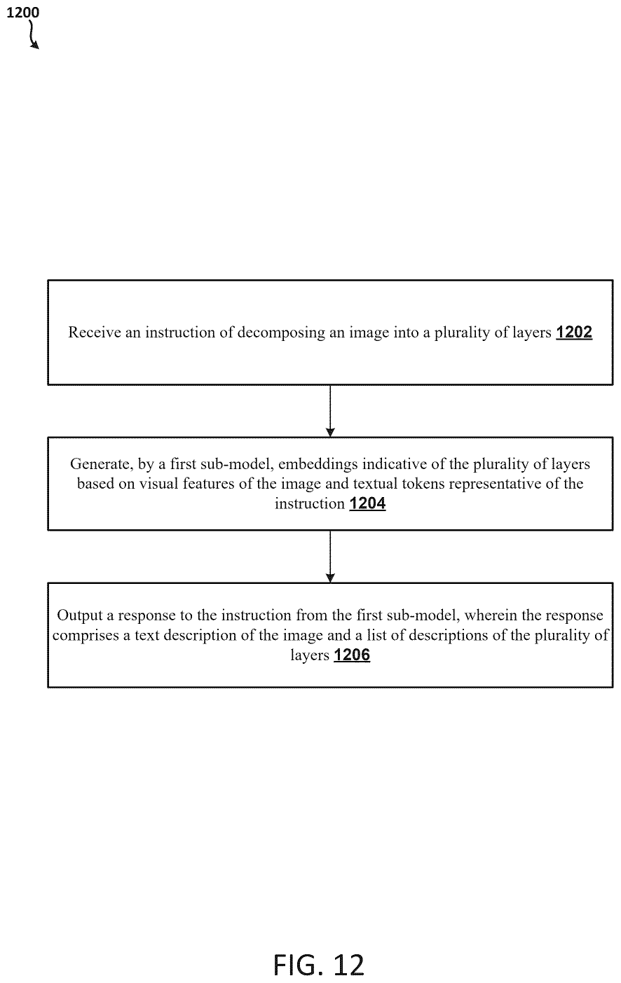

FIG. 12 shows an example process 1200 for processing images using a machine learning model. Although depicted as a sequence of operations in FIG. 12, those of ordinary skill in the art will appreciate that various embodiments may add, remove, reorder, or modify the depicted operations.

At 1202, an instruction (e.g., instruction 130) of decomposing an image (e.g., image 101) into a plurality of layers (e.g., plurality of layers 140a-n) can be received. The instruction can include natural-language human instructions that specify one or more criteria for decomposing the image into the plurality of layers. For example, the instruction can indicate a granularity level of decomposing the image. The instruction can include an instruction to decompose the image based on one or more objects in the image 101. The instruction can include an instruction to decompose the image based on a group of objects in the image. The instruction can indicate an order of decomposing the image (e.g., an order in which the plurality of layers is to be generated).

At 1204, embeddings (e.g., embeddings 250a-n) indicative of the plurality of layers can be generated. The embeddings can be generated based on the visual features and textual tokens (e.g., textual tokens 230) representative of the instruction. The embeddings can be generated by a first sub-model (e.g., first sub-model 240) of a machine learning model (e.g., machine learning model 102). The first sub-model can generate an embedding corresponding to each of the plurality of layers. For example, the first sub-model can generate a first embedding corresponding to the first layer among the plurality of layers, a second embedding corresponding to the second layer among the plurality of layers, a third embedding corresponding to the third layer among the plurality of layers, and so on.

At 1206, a response (e.g., response 420) can be output. The response can include a response to the instruction. The response can be generated by and output from the first sub-model. The response can include text description of the image and a list of descriptions of the plurality of layers. The response can include embeddings indicative of the plurality of layers. The response can be output in the form of a JSON file, for example.

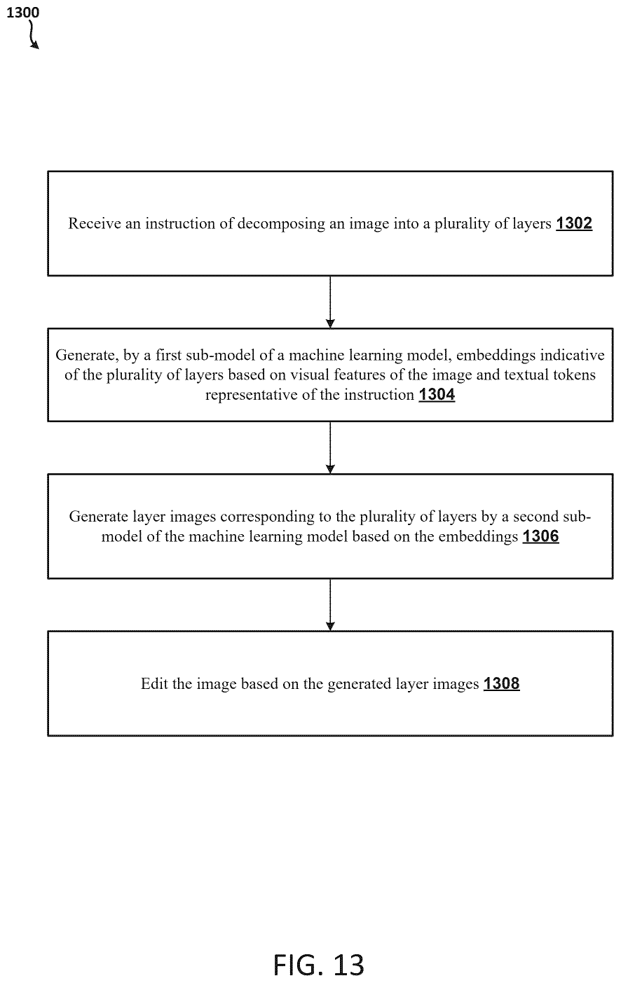

FIG. 13 shows an example process 1300 for processing images using a machine learning model. Although depicted as a sequence of operations in FIG. 13, those of ordinary skill in the art will appreciate that various embodiments may add, remove, reorder, or modify the depicted operations.

At 1302, an instruction (e.g., instruction 130) of decomposing an image (e.g., image 101) into a plurality of layers (e.g., plurality of layers 140a-n) can be received. The instruction can include natural-language human instructions that specify one or more criteria for decomposing the image into the plurality of layers. For example, the instruction can indicate a granularity level of decomposing the image. The instruction can include an instruction to decompose the image based on one or more objects in the image 101. The instruction can include an instruction to decompose the image based on a group of objects in the image. The instruction can indicate an order of decomposing the image (e.g., an order in which the plurality of layers is to be generated).

At 1304, embeddings (e.g., embeddings 250a-n) indicative of the plurality of layers can be generated. The embeddings can be generated based on the visual features and textual tokens (e.g., textual tokens 230) representative of the instruction. The embeddings can be generated by a first sub-model (e.g., first sub-model 240) of a machine learning model (e.g., machine learning model 102). The first sub-model can generate an embedding corresponding to each of the plurality of layers. For example, the first sub-model can generate a first embedding corresponding to the first layer among the plurality of layers, a second embedding corresponding to the second layer among the plurality of layers, a third embedding corresponding to the third layer among the plurality of layers, and so on.

At 1306, layer images (e.g., plurality of layers 140a-n) corresponding to the plurality of layers can be generated. The layer images can be generated by a second sub-model (e.g., second sub-model 360) of the machine learning model. The layer images can be generated based on the embeddings. For example, the second sub-model can generate a first layer image based on the embedding corresponding to the first layer, a second layer image based on the embedding corresponding to the second layer, a third layer image based on the embedding corresponding to the third layer, and so on. At 1308, the image can be edited based on the layer images. For example, a user can combine one or more of the layer images to generate an edited version of the image. A user can edit one or more of the individual layer image without affecting the other layer images.

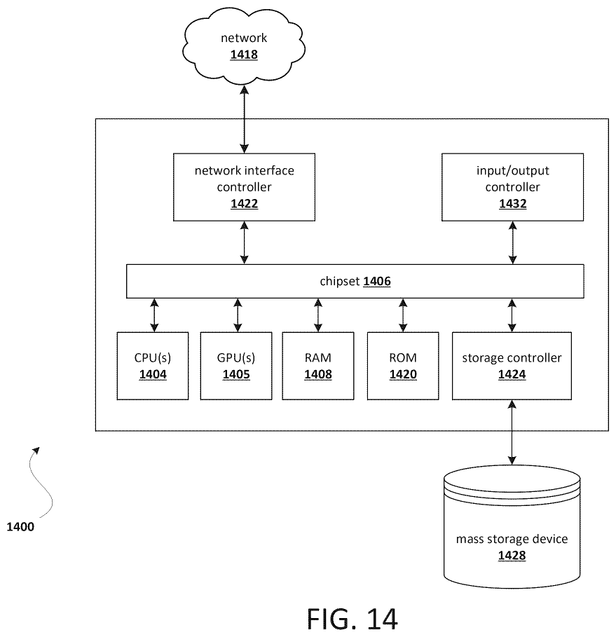

FIG. 14 illustrates a computing device that may be used in various aspects, such as the services, networks, modules, and/or devices depicted in any of FIGS. 1-4. With regard to FIGS. 1-5, any or all of the components may each be implemented by one or more instance of a computing device 1400 of FIG. 14. The computer architecture shown in FIG. 14 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1400 may include a baseboard, or “motherboard,” which is a printed circuit board to which a multitude of components or devices may be connected by way of a system bus or other electrical communication paths. One or more central processing units (CPUs) 1404 may operate in conjunction with a chipset 1406. The CPU(s) 1404 may be standard programmable processors that perform arithmetic and logical operations necessary for the operation of the computing device 1400.

The CPU(s) 1404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1404 may be augmented with or replaced by other processing units, such as GPU(s) 1405. The GPU(s) 1405 may comprise processing units specialized for but not necessarily limited to highly parallel computations, such as graphics and other visualization-related processing.

A chipset 1406 may provide an interface between the CPU(s) 1404 and the remainder of the components and devices on the baseboard. The chipset 1406 may provide an interface to a random-access memory (RAM) 1408 used as the main memory in the computing device 1400. The chipset 1406 may further provide an interface to a computer-readable storage medium, such as a read-only memory (ROM) 1420 or non-volatile RAM (NVRAM) (not shown), for storing basic routines that may help to start up the computing device 1400 and to transfer information between the various components and devices. ROM 1420 or NVRAM may also store other software components necessary for the operation of the computing device 1400 in accordance with the aspects described herein.

The computing device 1400 may operate in a networked environment using logical connections to remote computing nodes and computer systems through local area network (LAN). The chipset 1406 may include functionality for providing network connectivity through a network interface controller (NIC) 1422, such as a gigabit Ethernet adapter. A NIC 1422 may be capable of connecting the computing device 1400 to other computing nodes over a network 1416. It should be appreciated that multiple NICs 1422 may be present in the computing device 1400, connecting the computing device to other types of networks and remote computer systems.

The computing device 1400 may be connected to a mass storage device 1428 that provides non-volatile storage for the computer. The mass storage device 1428 may store system programs, application programs, other program modules, and data, which have been described in greater detail herein. The mass storage device 1428 may be connected to the computing device 1400 through a storage controller 1424 connected to the chipset 1406. The mass storage device 1428 may consist of one or more physical storage units. The mass storage device 1428 may comprise a management component. A storage controller 1424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1400 may store data on the mass storage device 1428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1428 is characterized as primary or secondary storage and the like.

For example, the computing device 1400 may store information to the mass storage device 1428 by issuing instructions through a storage controller 1424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1400 may further read information from the mass storage device 1428 by detecting the physical states or characteristics of one or more particular locations within the physical storage units.

In addition to the mass storage device 1428 described above, the computing device 1400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1428 depicted in FIG. 14, may store an operating system utilized to control the operation of the computing device 1400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1428 may store other system or application programs and data utilized by the computing device 1400.

The mass storage device 1428 or other computer-readable storage media may also be encoded with computer-executable instructions, which, when loaded into the computing device 1400, transforms the computing device from a general-purpose computing system into a special-purpose computer capable of implementing the aspects described herein. These computer-executable instructions transform the computing device 1400 by specifying how the CPU(s) 1404 transition between states, as described above. The computing device 1400 may have access to computer-readable storage media storing computer-executable instructions, which, when executed by the computing device 1400, may perform the methods described herein.

A computing device, such as the computing device 1400 depicted in FIG. 14, may also include an input/output controller 1432 for receiving and processing input from a number of input devices, such as a keyboard, a mouse, a touchpad, a touch screen, an electronic stylus, or other type of input device. Similarly, an input/output controller 1432 may provide output to a display, such as a computer monitor, a flat-panel display, a digital projector, a printer, a plotter, or other type of output device. It will be appreciated that the computing device 1400 may not include all of the components shown in FIG. 14, may include other components that are not explicitly shown in FIG. 14, or may utilize an architecture completely different than that shown in FIG. 14.

As described herein, a computing device may be a physical computing device, such as the computing device 1400 of FIG. 14. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed IS:

1. A method of processing an image using a machine learning model, comprising:
receiving an instruction of decomposing the image into a plurality of layers;
generating visual features of the image;
generating embeddings indicative of the plurality of layers based on the visual features and textual tokens representative of the instruction by a first sub-model of the machine learning model; and
generating layer images corresponding to the plurality of layers by a second sub-model of the machine learning model based on the embeddings.

2. The method of claim 1, further comprising:
inputting the image into the second sub-model; and
projecting the embeddings to align with noised latent representations of the image.

3. The method of claim 1, further comprising:
generating a latent representation for each of the plurality of layers based on noised latent representations of the image and a corresponding embedding among the embeddings indicative of the plurality of layers.

4. The method of claim 3, further comprising:
generating an alpha channel corresponding to each of the plurality of layers based on the latent representation by a first decoder; and
generating a red, green, and blue (RGB) image corresponding to each of the plurality of layers based on the latent representation by a second decoder.

5. The method of claim 4, further comprising:
generating each of the layer images by concatenating the alpha channel and the RGB image.

6. The method of claim 1, further comprising:
generating the textual tokens representative of the instruction by a tokenizer;
generating the visual features of the image by a visual encoder;
projecting the visual features to align with the textual tokens; and
inputting the textual tokens and the projected visual features into the first sub-model for generating the embeddings.

7. The method of claim 1, further comprising:
outputting a response to the instruction from the first sub-model, wherein the response comprises a text description of the image and a list of descriptions of the plurality of layers.

8. The method of claim 1, further comprising:
editing the image based on the generated layer images.

9. The method of claim 1, wherein the instruction comprises at least one of:
an instruction indicating a granularity level of decomposing the image;
an instruction to decompose the image based on one or more objects in the image; or
an instruction to decompose the image based on a group of objects in the image.

10. A system of processing an image using a machine learning model, comprising:
at least one processor; and
at least one memory communicatively coupled to the at least one processor and comprising computer-readable instructions that upon execution by the at least one processor cause the at least one processor to perform operations comprising:
receiving an instruction of decomposing the image into a plurality of layers;
generating visual features of the image;
generating embeddings indicative of the plurality of layers based on the visual features and textual tokens representative of the instruction by a first sub-model of the machine learning model; and
generating layer images corresponding to the plurality of layers by a second sub-model of the machine learning model based on the embeddings.

11. The system of claim 10, the operations further comprising:
inputting the image into the second sub-model; and
projecting the embeddings to align with noised latent representations of the image.

12. The system of claim 10, the operations further comprising:
generating a latent representation for each of the plurality of layers based on noised latent representations of the image and a corresponding embedding among the embeddings indicative of the plurality of layers.

13. The system of claim 12, the operations further comprising:
generating an alpha channel corresponding to each of the plurality of layers based on the latent representation by a first decoder; and
generating a red, green, and blue (RGB) image corresponding to each of the plurality of layers based on the latent representation by a second decoder; and
generating each of the layer images by concatenating the alpha channel and the RGB image.

14. The system of claim 10, the operations further comprising:
generating the textual tokens representative of the instruction by a tokenizer;
generating the visual features of the image by a visual encoder;
projecting the visual features to align with the textual tokens; and
inputting the textual tokens and the projected visual features into the first sub-model for generating the embeddings.

15. The system of claim 10, wherein the instruction comprises at least one of:
an instruction indicating a granularity level of decomposing the image;
an instruction to decompose the image based on one or more objects in the image; or
an instruction to decompose the image based on a group of objects in the image.

16. A non-transitory computer-readable storage medium, storing computer-readable instructions that upon execution by a processor cause the processor to implement operations comprising:
receiving an instruction of decomposing the image into a plurality of layers;
generating visual features of the image;
generating embeddings indicative of the plurality of layers based on the visual features and textual tokens representative of the instruction by a first sub-model of the machine learning model; and
generating layer images corresponding to the plurality of layers by a second sub-model of the machine learning model based on the embeddings.

17. The non-transitory computer-readable storage medium of claim 16, the operations further comprising:
inputting the image into the second sub-model; and
projecting the embeddings to align with noised latent representations of the image.

18. The non-transitory computer-readable storage medium of claim 16, the operations further comprising:
generating a latent representation for each of the plurality of layers based on noised latent representations of the image and a corresponding embedding among the embeddings indicative of the plurality of layers.

19. The non-transitory computer-readable storage medium of claim 16, the operations further comprising:
generating an alpha channel corresponding to each of the plurality of layers based on the latent representation by a first decoder; and
generating a red, green, and blue (RGB) image corresponding to each of the plurality of layers based on the latent representation by a second decoder; and
generating each of the layer images by concatenating the alpha channel and the RGB image.

20. The non-transitory computer-readable storage medium of claim 16, the operations further comprising:
generating the textual tokens representative of the instruction by a tokenizer;
generating the visual features of the image by a visual encoder;
projecting the visual features to align with the textual tokens; and
inputting the textual tokens and the projected visual features into the first sub-model for generating the embeddings.
